(19) United States
(12) Patent Application Publication
(10) Pub. No.: US 2020/0076122 A1
(43) Pub. Date: Mar. 5, 2020

(54) ELECTRICAL PLUG CONNECTOR, ELECTRICAL RECEPTACLE CONNECTOR AND CONNECTOR ASSEMBLY

(71) Applicant: Molex, LLC, Lisle, IL (US)

(72) Inventors: Hao YIN, Shanghai (CN); Xue-Qing ZHANG, Shanghai (CN); Teng Fei ZHANG, Shanghai (CN)

(73) Assignee: Molex, LLC, Lisle, IL (US)

(21) Appl. No.: 16/559,632

(22) Filed: Sep. 4, 2019

(30) Foreign Application Priority Data
Sep. 5, 2018 (CN) 201811032606.8

(51) Int. Cl. H01R 13/62; H01R 39/64

(52) U.S. Cl. CPC H01R 13/6205; H01R 2107/00; H01R 39/64

(57) ABSTRACT

The present disclosure provides an electrical plug connector, an electrical receptacle connector and a connector assembly having the electrical plug connector and the electrical receptacle connector. The electrical plug connector comprises a plug main body, a ring magnet sheathing the plug main body and at least two movable terminals fixed in the plug main body, a top surface of the ring magnet is flush with a circumferential edge of a top surface of an inserting portion of the plug main body. The electrical receptacle connector comprises a receptacle main body, a attraction ring sheathing the receptacle main body and at least two conductive metal posts fixed on the receptacle main body, a top surface of the attraction ring is flush with a top surface of the receptacle main body. The ring magnet of the electrical plug connector is capable of being magnetically attracted with the attraction ring of the electrical receptacle connector, the at least two movable terminals of the electrical plug connector are electrically connected with the at least two conductive metal posts of the electrical receptacle connector correspondingly. The present disclosure is simplified in structure, convenient to manufacture and lower in cost.

### RELATED APPLICATIONS

This application claims priority to Chinese Application No, 201811032606.8, filed on Sep. 5, 2018, which application is incorporated herein by reference in its entirety.

### TECHNICAL FIELD

The present disclosure relates to an electrical connector, and particularly relates to an electrical plug connector, an electrical receptacle connector and a connector assembly having the electrical plug connector and the electrical receptacle connector which is simplified in structure and is easy to manufacture.

### BACKGROUND ART

Chinese utility model patent CN207542466U discloses an electrical receptacle connector and an electrical plug connector. The electrical receptacle connector comprises: a receptacle main body comprising receptacle terminal grooves; pin terminals each provided in each receptacle terminal groove, two ends of each pin terminal respectively comprises a first contact portion protruding from one side of the receptacle terminal groove and a first soldering portion protruding from the other side of the receptacle terminal groove; and a first magnetic ring sheathing the receptacle main body, one surface of the first magnetic ring comprises a mating groove and a first fool-proof portion formed on an inner side surface of the mating groove, each first contact portion provided inside the mating groove. The electrical plug connector comprises: a plug main body comprising plug terminal grooves, a mating protrusion, and a second fool-proof portion formed on an outer side surface of the mating protrusion; plug terminals each provided in each plug terminal groove, two ends of each plug terminal respectively comprises a second contact portion positioned to the mating protrusion and exposed on one side of each plug terminal groove and a second soldering portion protruding from the other side of the plug terminal groove; and a second magnetic ring, the second magnetic ring comprises a sheathing groove for sheathing the plug main body, the mating protrusion protrudes from one side of the second magnetic ring. The magnetic ring of this design is special in shape, difficult to process and higher in cost and the magnetic ring having magnetic force may interfere with the magnetic element in a device and is not suitable for use on the device end.

### SUMMARY

The technical problem to be resolved by the present disclosure is to provide an electrical plug connector, an electrical receptacle connector and a connector assembly which is simplified in structure, easy to manufacture and lower in cost.

According to one solution of the present disclosure, the present disclosure provides an electrical plug connector comprising a plug main body, a ring magnet and at least two movable terminals. The plug main body comprises a base and an inserting portion protruding upwardly from the base. The ring magnet has a hollow ring shape and sheathes an outer circumferential surface of the inserting portion therein, a top surface of the ring magnet is flush with an circumferential edge of a top surface of the inserting portion. Each movable terminal comprises a terminal base and a movable contact capable of moving up and down relative to the terminal base, the terminal base is fixed in the plug main body and protrudes downwardly; the movable contact protrudes upwardly from the top surface of the inserting portion.

According to another solution of the present disclosure, the present disclosure further provides an electrical receptacle connector comprising a receptacle main body, an attraction ring and at least two conductive metal posts. The receptacle main body comprises a base and a mating portion protruding upwardly from the base. The attraction ring has a hollow ring shape and sheathes an outer circumferential surface of the mating portion of the receptacle main body therein, a top surface of the attraction ring is flush with a top surface of the mating portion, the attraction ring is made of ferromagnetic material. The at least two conductive metal posts are fixed in the receptacle main body; each conductive metal post has a front end fixed in the mating portion and a rear end correspondingly positioned in the base.

According to still another solution of the present disclosure, the present disclosure further provides. a connector assembly comprising the electrical plug connector as described above and the electrical receptacle connector as described above; the ring magnet of the electrical plug connector is magnetically attracted with the attraction ring of the electrical receptacle connector together, the at least two movable terminals of the electrical plug connector being electrically connected with the at least two conductive metal posts of the electrical receptacle connector correspondently.

In comparison with the prior art, the present disclosure at least has the following advantages: in the present disclosure, a ring magnet is adopted in the electrical plug connector, and a ring attraction ring is adopted in the electrical receptacle connector, the magnetic attraction of the ring magnet and the attraction ring facilitates the firm mating of the electrical plug connector and the electrical receptacle connector, so that a reliable electrical connection between the movable terminal and the conductive metal post is established. The ring magnet and the attraction ring are both regular shaped, simplified in structure, convenient to manufacture and lower in cost. Particularly, in the electrical receptacle connector, the attraction ring is made of a ferromagnetic material, which itself is not magnetic or has only weak magnetic properties, when the electrical receptacle connector is mounted in an electronic device, the attraction ring will not interfere with magnetic elements of the electronic device, the performance of the electronic device is guaranteed. In addition, the design that the top surface of the attraction ring is flush with the top surface of the receptacle main body is also convenient to allow the electrical receptacle connector to be closely attached on the inner surface of the electronic device or be exposed to the exterior surface of the electronic device without protruding outwardly, which is convenient for industrial application and has an improved waterproof capability.

### BRIEF DESCRIPTION OF DRAWINGS

FIG. 1 is a perspective schematic view of a first embodiment of a connector assembly of the present disclosure.

FIG. 2 is a perspective schematic view of FIG. 1 from another angle.

FIG. 3 is a front view of FIG. 1.

FIG. 4 is a cross sectional view along a line A-A of FIG. 3.

FIG. 5 and FIG. 6 are perspective exploded structure schematic views of FIG. 1 from two different angles.

FIG. 7 is a perspective schematic view of a second embodiment of the connector assembly of the present disclosure.

FIG. 8 is a perspective schematic view of FIG. 7 from another angle.

FIG. 9 is a front view of FIG. 7.

FIG. 10 is a cross sectional view along a line B-B of FIG. 9.

FIG. 11 and FIG. 12 are perspective exploded structure schematic views of FIG. 7 from two different angles.

### DETAILED DESCRIPTION OF THE PREFERRED EMBODIMENTS

While the present disclosure may be susceptible to embodiments in different forms, there are shown in the figures, and will be described herein in detail, are only specific embodiments, with the understanding that the present disclosure is to be considered as an exemplification of the principles of the present disclosure, and is not intended to limit the present disclosure to that as illustrated.

As such, references to a feature are intended to describe a feature of an embodiment of the present disclosure do not to imply that every embodiment thereof must have the described feature. Furthermore, it should be noted that the description illustrates a number of features. While certain features may be combined together to illustrate potential system designs, those features may also be used in other combinations not expressly described. Thus, the described combinations are not intended to be limiting, unless otherwise noted.

In the embodiments illustrated in the figures, representations of directions such as up, down, left, right, front and rear, used for explaining the structure and movement of the various components of the present disclosure, are not absolute, but relative. These representations are appropriate when the components are in the position shown in the figures. If the description of the position of the components changes, however, these representations are to be changed accordingly.

Hereinafter, embodiments of the present disclosure are further described in detail in combination with the figures of the present disclosure.

### A First Embodiment

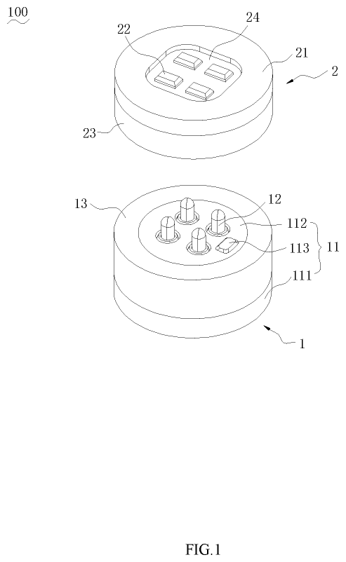

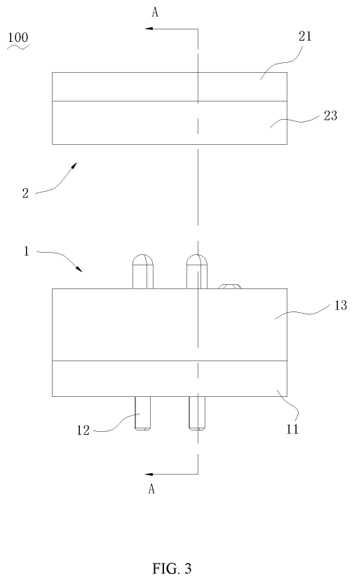

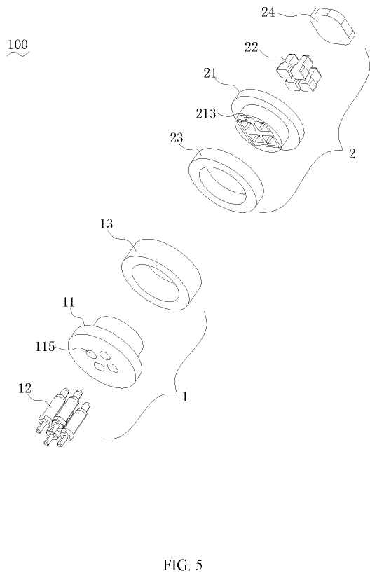

Referring to FIG. 1 to FIG. 6, a connector assembly 100 of the present embodiment comprises an electrical plug connector 1 and an electrical receptacle connector 2 which is matched with the electrical plug connector 1. The electrical plug connector 1 is used for being mounted to a cable end, such as a charging data cable and the like. The electrical receptacle connector 2 is used for being mounted to a device end, such as an electronic device, for example a notebook computer, a mobile phone and the like.

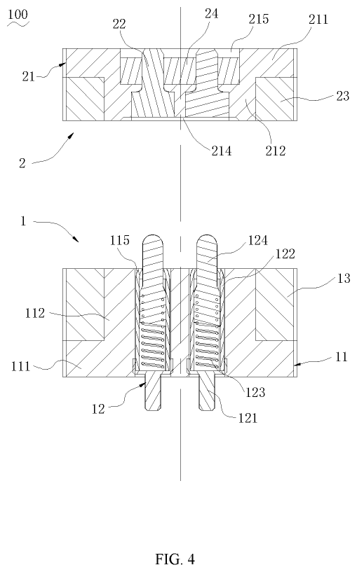

Referring to FIG. 4 to FIG. 6, the electrical plug connector 1 comprises a plug main body 11, a ring magnet 13 sheathing an upper end of the plug main body 11 and four movable terminals 12 fixed on the plug main body 11.

The plug main body 11 comprises a base 111 and an inserting portion 112 protruding upwardly from the base 111, and preferably further comprises a fool-proof portion 113 protruding upwardly from a position of a top surface of the inserting portion 112 close to an edge of the top surface of the inserting portion 112. The plug main body 11 is preferably made of an insulating plastic and may be formed as an integral structure by injection molding.

The base 111 and the inserting portion 112 are both cylindrical, and are coaxial. A radius of the base 111 is larger than a radius of the inserting portion 112, so that a contour of the plug main body 11 is substantially configured as a stepped structure.

The terminal base 11 is provided with four terminal grooves 115, the four terminal grooves 115 are arranged to define a rectangular region, and each terminal groove 115 penetrates from a bottom surface of the base 111 to the top surface of the inserting portion 112. In other embodiments not shown, the number and the arrangement of the terminal grooves 115 may be flexibly arranged according to actual needs.

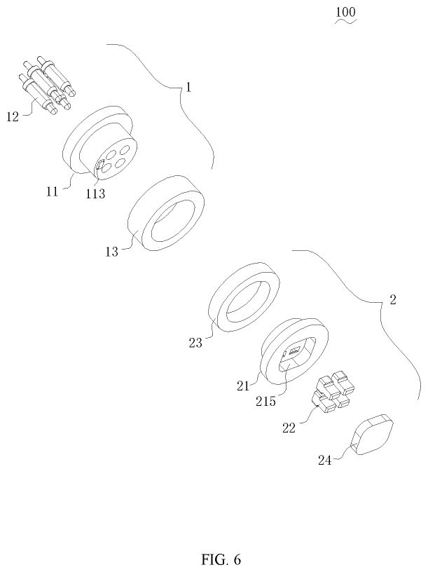

The fool-proof portion 113 acts as a foolproof function and facilitates the accurate mating of the electrical plug connector 1 and the electrical receptacle connector 2 along a unique mating direction. As shown in FIG. 1 and FIG. 6, in the present embodiment, the fool-proof portion 13 is substantially a rectangular protruding block positioned outside the rectangular region defined by the four terminal grooves 115 and spaced apart from each terminal groove 115. An outer circumferential surface of the fool-proof portion 113 is an oblique surface and functions as guiding.

The four movable terminals 12 comprise two power terminals used for transmitting power and two signal terminals used for transmitting signal. The four movable terminals 12 are fixed in the terminal grooves 115 of the plug main body 11 in a one-to-one correspondence. Referring to FIG. 4, the movable terminal 12 is a pogo pin (spring-type pin), and comprises a terminal base 121, a sleeve 122 fixed on the terminal base 121, a spring 123 provided inside the sleeve 122 and a movable contact 124. Two ends of the spring 123 respectively abut against the terminal base 121 and the movable contact 124. An upper end of the movable contact 124 extends out of the sleeve 122, and the movable contact 124 can move up and down elastically relative to the terminal base 121 through the spring 123. The terminal base 121 is fixed in the plug main body 11 and extends downwardly out of a bottom of the base 111; the sleeve 122 is received in the terminal groove 115; the upper end of the movable contact 124 extends upwardly from the top surface of the inserting portion 112. In other embodiments not shown, the number and the arrangement of the movable terminals 12 may be determined depend on actual requirements, for example, only two movable terminals 12 may be provided for transmitting the power.

Referring to FIG. 1 to FIG. 6, the ring magnet 13 has a hollow circular ring shape, sheathing an outer circumferential surface of the inserting portion 112 of the plug main body 11 therein. A top surface of the ring magnet 13 is flush with a circumferential edge of the inserting portion 112. A bottom surface of the ring magnet 13 abuts against a top surface of the base 111, and an outer circumferential surface of the ring magnet 13 is flush with an outer circumferential surface of the base 111. The ring magnet 13 and the plug main body 11 can be fixed by means of bonding or interference fit or a tenon structure. The ring magnet 13 may be made of a ferrite magnet or a neodymium iron boron magnet.

Referring to FIG. 4 to FIG. 6, the electrical receptacle connector 2 comprises a receptacle main body 21, an attraction ring 23 sheathing an upper end of the receptacle main body 21 and four conductive metal posts 22 fixed in the receptacle main body 21. Preferably, a rear end of the conductive metal posts 22 is further provided with a waterproof adhesive 24.

The receptacle main body 21 is formed on the conductive metal posts 22 by inserting molding. The receptacle main body 21 comprises a base 211 and a mating portion 212 protruding upwardly from the base 211. The base 211 and the mating portion 212 are both cylindrical and are coaxial. A radius of the base 211 is larger than a radius of the mating portion 212, a contour of the receptacle main body 21 is configured as a stepped structure.

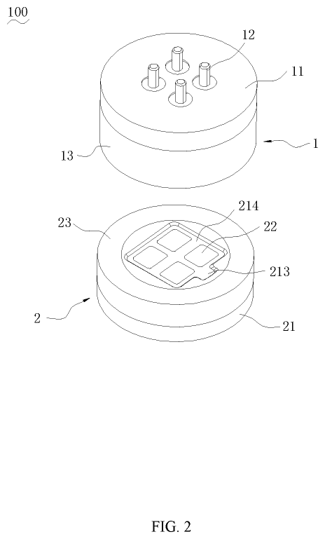

As shown in FIG. 2, a center of a top surface of the mating portion 212 is recessed downwardly to form a mating groove 214 which is substantially rectangular, a middle of a side wall of the mating groove 214 is recessed outwardly to form an orientation groove 213. The orientation groove 213 is substantially rectangle, a length of a side of the rectangle is shorter than a length of a side of the mating groove 214. The orientation groove 213 matches with the fool-proof portion 113 of the electrical plug connector 1, facilitating accurate mating of the electrical receptacle connector 2 with the electrical plug connector 1 in the unique mating direction. A side wall of the orientation groove 213 is an oblique surface functioning as guiding.

Referring to FIG. 4 and FIG. 6, the receptacle main body 21 is further formed with an adhesive storage groove 215 recessed from a bottom surface of the base 211 for receiving the waterproof adhesive 24.

The four conductive metal posts 22 are arranged to define a rectangular region and correspond to the functions of the four movable terminals 12 of the electrical plug connector 1, two of the four conductive metal posts 22 are used for transmitting power, and the other two of the four conductive metal posts 22 are used for transmitting signal. Referring to FIG. 2 and FIG. 4, the four conductive metal posts 22 are positioned in the mating groove 214, and a front end of each conductive metal post 22 is connected and fixed by the mating portion 212 of the receptacle main body 21, and a front end surface of each conductive metal post 22 is flush with a bottom surface of the mating groove 214. Further referring to FIG. 1 and FIG. 4, a rear end of each conductive metal post 22 is positioned in the adhesive storage groove 215 of the receptacle main body 21.

The waterproof adhesive 24 is filled in a gap between each conductive metal post 22 and the adhesive storage groove 215 to prevent external water from entering into the inside of the device through the gap between the conductive metal post 22 and the receptacle main body 21, thereby improving the sealing and waterproofing capability.

Referring to FIG. 1 to FIG. 6, the attraction ring 23 is a hollow circular ring shape and sheathes an outer circumferential surface of the mating portion 212 of the receptacle main body 21 therein. A top surface of the attraction ring 23 is flush with a top surface of the mating portion 212. A bottom surface of the attraction ring 23 abuts against a top surface of the base 211, and an outer circumferential surface of the attraction ring 23 is flush with an outer circumferential surface of the base 211. The attraction ring 23 and the receptacle main body 21 may be fixed together by insert molding, bonding, interference fit and the like. The attraction ring 23 is preferably made of a ferromagnetic material, such as soft iron, silicon steel, nickel iron alloy and the like.

An contour of the electrical receptacle connector 2 of the present embodiment is a regular cylindrical shape, facilitating mounting the electrical receptacle connector 2 in the device, and a top surface of the electrical receptacle connector 2 can be exposed on an exterior surface of the device without protruding from the exterior surface, which is convenient to be applied to a portable electronic device and has a strong waterproof sealing performance.

When the electrical plug connector 1 and the electrical receptacle connector 2 are mated, the ring magnet 13 of the electrical plug connector 1 and the attraction ring 23 of the electrical receptacle connector 2 are magnetically attracted together, the electrical plug connector 1 and the receptacle connector 2 can be mated only in one direction by matching the fool-proof portion 113 of the electrical plug connector 1 with the orientation groove 213 of the electrical receptacle connector 2. Therefore, the movable terminals 12 of the electrical plug connector 1 are electrically connected to the conductive metal posts 22 of the electrical receptacle connector 2 in one-to-one correspondence.

### A Second Embodiment

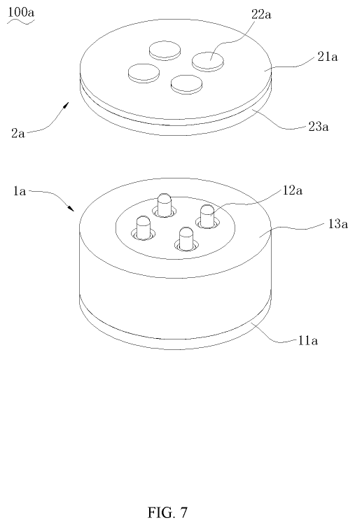

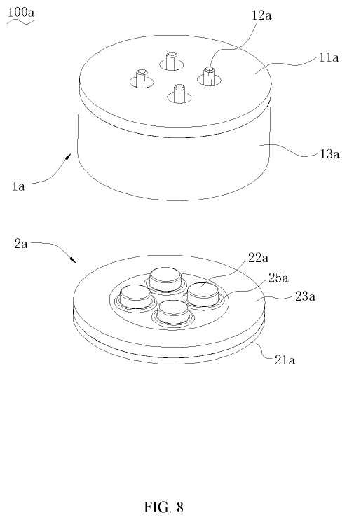

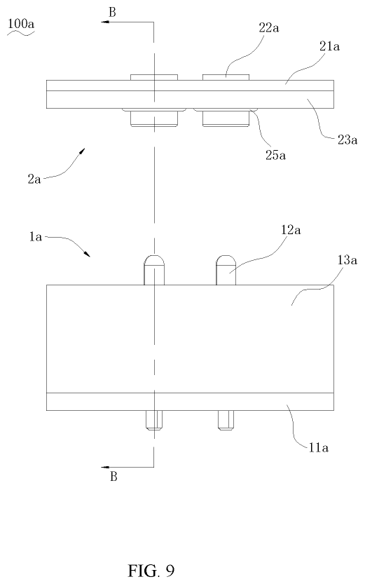

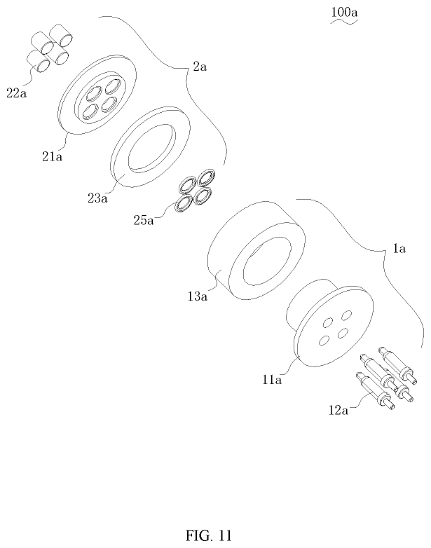

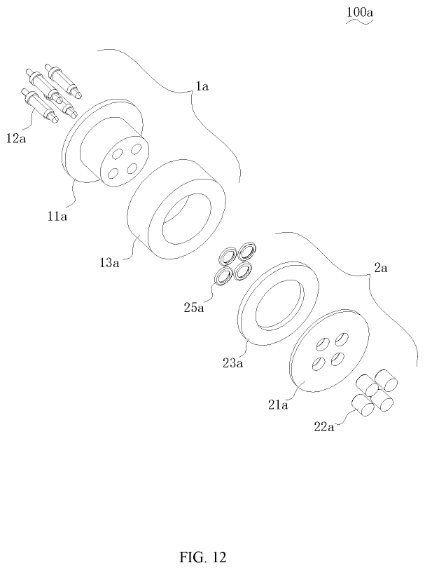

Referring to FIG. 7 to FIG. 12, a connector assembly 100a of the present embodiment also comprises a electrical plug connector 1a and an electrical receptacle connector 2a which matches with the electrical plug connector 1a.

The structure of the electrical plug connector 1a is substantially the same as that of the electrical plug connector 1 in the first embodiment, and also comprises a plug main body 11a, a ring magnet 13a sheathing an upper end of the plug main body 11a and four movable terminals 12a fixed in the plug main body 11a. The difference lies in that, in the electrical plug connector 1a of the present embodiment, the plug main body 11a is not provided with the fool-proof portion 113. Other structure of the electrical plug connector 1a can be referred to the first embodiment and will not be described in detail herein.

The structure of the electrical receptacle connector 2a is substantially the same as that of the electrical receptacle connector 2 in the first embodiment, and also comprises a receptacle main body 21a, an attraction ring 23 fixedly sheathing an upper end of the receptacle main body 21a and four conductive metal posts 22 fixed in the receptacle main body 21.

The electrical receptacle connector 2a is different from the electrical receptacle connector 2 of the first embodiment in that, in the electrical receptacle connector 2a of the present embodiment, the electrical receptacle connector 2a is not provided with the orientation groove 213 and the mating groove 214. The unique directional mating of the electrical receptacle connector 2a and the electrical plug connector 1a of the present embodiment can be achieved by a mating housing attached to the exterior of the connector assembly 100a, such as a suitable foolproof structure (not shown) provided on the housing of the device to which the electrical receptacle connector 2a is applied, etc; in some cases, the foolproof structure may not be provided, so that the electrical plug connector 1a and the electrical receptacle connector 2a may be mated in four different directions.

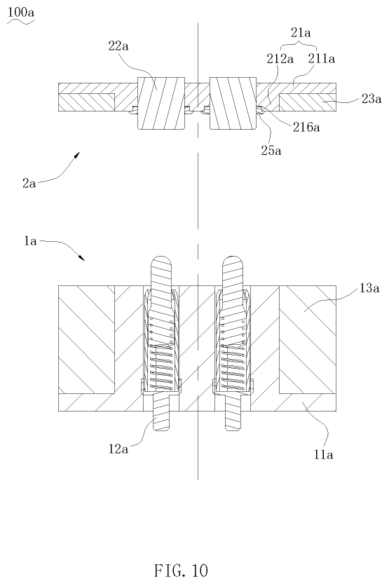

Referring to FIG. 10, in the electrical receptacle connector 2a of the present embodiment, each conductive metal post 22a is fixed in the receptacle main body 21a by a process of inserting molding, and the receptacle main body 21a is no longer provided with a adhesive storage groove 215, correspondingly, the waterproof adhesive 24 is no longer provided between each conductive metal post 22a and the base 211a. A front end of each conductive metal post 22a protrudes from a top surface of mating portion 212a of the receptacle main body 21a, the top surface of the mating portion 212a is provided with sealing grooves 216a each surrounding each conductive metal post 22a, the front end of each conductive metal post 22a is sheathed with a sealing ring 25a, and the seal rings 25a are respectively filled in the sealing grooves 216a. The sealing ring 25a can seal the tiny gap between each conductive metal post 22a and the receptacle main body 21a caused by thermal expansion and cold contraction, thereby achieving higher waterproof requirements. A top surface of the sealing ring 25a also protrudes from the top surface of the mating portion 212a. When the electrical receptacle connector 2a is mounted in an electronic device (not shown), only a front end surface of the conductive metal post 22a is exposed to the outside through an opening on an outer housing of the electronic device, and the top surface of the sealing ring 25a can closely abut against an inner surface of the outer housing of the electronic device, thereby improving the waterproof capability of the device.

According to the explanation of the above embodiments, in the present disclosure, a ring magnet 13/13a is adopted in the electrical plug connector 1/1a, and a ring attraction ring 23/23a is adopted in the electrical receptacle connector 2/2a, the magnetic attraction of the ring magnet 13/13a and the attraction ring 23/23a facilitates the firm mating of the electrical plug connector 1/1a and the electrical receptacle connector 2/2a, so that a reliable electrical connection between the movable terminal 12/12a and the conductive metal post 22 is established. The ring magnet 13/13a and the attraction ring 23/23a are both regular shaped, simplified in structure, convenient to manufacture and lower in cost. In the electrical receptacle connector 2/2a, the attraction ring 23/23a is made of a ferromagnetic material, which itself is not magnetic or has only weak magnetic properties, when the electrical receptacle connector 2/2a is mounted in an electronic device, the attraction ring will not interfere with magnetic elements of the electronic device, the performance of the electronic device is guaranteed. In addition, the design that the top surface of the attraction ring 23/23a is flush with the top surface of the receptacle main body 21/21a is also convenient to allow the electrical receptacle connector 2/2a to be closely attached on the inner surface of the electronic device or be exposed to the exterior surface of the electronic device without protruding outwardly, which is convenient for industrial application and has an improved waterproof capability.

The above described contents are only the preferred embodiments of the present disclosure, which cannot limit the implementing solutions of the present disclosure, those skilled in the art may conveniently make corresponding variation or modification based on the main concept and spirit of the present disclosure, therefore the extent of protection of the present disclosure shall be determined by terms of the Claims.

1. An electrical plug connector, comprising:
a plug main body comprising a base and an inserting portion protruding upwardly from the base;
a ring magnet having a hollow ring shape and sheathing an outer circumferential surface of the inserting portion therein, a top surface of the ring magnet being flush with an circumferential edge of a top surface of the inserting portion;
at least two movable terminals, each movable terminal comprising a terminal base and a movable contact capable of moving up and down relative to the terminal base, the terminal base being fixed in the plug main body and protruding downwardly; the movable contact protruding upwardly from the top surface of the inserting portion.

2. The electrical plug connector according to claim 1, wherein the plug main body further comprises a fool-proof portion protruding upwardly from the top surface of the inserting portion.

3. The electrical plug connector according to claim 2, wherein the at least two movable terminals are four movable terminals which define a rectangular region; the fool-proof portion is positioned outside the rectangular region defined by the four movable terminals, and the fool-proof portion is a protruding block with a rectangular shape.

4. The electrical plug connector according to claim 1, wherein a bottom surface of the ring magnet abuts against the top surface of the base, and an outer circumferential surface of the ring magnet is flush with an outer circumferential surface of the base.

5. An electrical receptacle connector, comprising:
a receptacle main body comprising a base and a mating portion protruding upwardly from the base;
an attraction ring having a hollow ring shape and sheathing an outer circumferential surface of the mating portion of the receptacle main body therein, a top surface of the attraction ring being flush with a top surface of the mating portion, the attraction ring being made of ferromagnetic material;
at least two conductive metal posts fixed in the receptacle main body; each conductive metal post having a front end fixed in the mating portion and a rear end correspondingly positioned in the base.

6. The electrical receptacle connector according to claim 5, wherein the top surface of the mating portion is further provided with an orientation groove.

7. The electrical receptacle connector according to claim 6, wherein the top surface of the mating portion is recessed downwardly to form a mating groove, the at least two conductive metal posts are four conductive metal posts which define a rectangular region, and the four conductive metal posts are positioned in the mating groove; the orientation groove is recessed from a middle of a side wall of the mating groove, the orientation groove is a rectangular shape.

8. The electrical receptacle connector according to claim 5, wherein an adhesive storage groove is provided at a rear portion of the base, and a waterproof adhesive is further filled between the rear ends of the conductive metal posts and the adhesive storage groove.

9. The electrical receptacle connector according to claim 5, wherein the front end of each conductive metal post protruding from the top surface of mating portion; the mating portion is provided with several sealing grooves each surrounding each conductive metal post therein, the front end of each conductive metal post is sheathed by a sealing ring, the seal ring is arranged in the sealing groove and protruding from the top surface of the mating portion.

10. A connector assembly, comprising:
an electrical plug connector, comprising:
a plug main body comprising a base and an inserting portion protruding upwardly from the base;
a ring magnet having a hollow ring shape and sheathing an outer circumferential surface of the inserting portion therein, a top surface of the ring magnet being flush with an circumferential edge of a top surface of the inserting portion;
at least two movable terminals, each movable terminal comprising a terminal base and a movable contact capable of moving up and down relative to the terminal base, the terminal base being fixed in the plug main body and protruding downwardly; the movable contact protruding upwardly from the top surface of the inserting portion; and
an electrical receptacle connector, comprising:
a receptacle main body comprising a base and a mating portion protruding upwardly from the base;
an attraction ring having a hollow ring shape and sheathing an outer circumferential surface of the mating portion of the receptacle main body therein, a top surface of the attraction ring being flush with a top surface of the mating portion, the attraction ring being made of ferromagnetic material;
at least two conductive metal posts fixed in the receptacle main body; each conductive metal post having a front end fixed in the mating portion and a rear end correspondingly positioned in the base,
wherein the ring magnet of the electrical plug connector is magnetically attracted with the attraction ring of the electrical receptacle connector together, the at least two movable terminals of the electrical plug connector is electrically connected with the at least two conductive metal posts of the electrical receptacle connector correspondently.
